(19) United States
(12) Patent Application Publication
(10) Pub. No.: US 2009/0290797 A1
(43) Pub. Date: Nov. 26, 2009

(54) IMAGE PROCESSING FOR STORING OBJECTS SEPARATED FROM AN IMAGE IN A STORAGE DEVICE

(75) Inventors: Junya Arakawa, Kawasaki-shi (JP); Hiroshi Kaburagi, Yokohama-shi (JP); Tsutomu Sakaue, Yokohama-shi (JP); Takeshi Namikala, Yokohama-shi (JP); Manabu Takebayashi, Isehara-shi (JP); Reiji Misawa, Tokyo (JP); Osamu Iinuma, Machida-shi (JP); Naoki Ito, Tokyo (JP); Yoichi Kashibuchi, Tokyo (JP); Shinji Sano, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/369,305

(22) Filed: Feb. 11, 2009

(30) Foreign Application Priority Data
Feb. 13, 2008 (JP) 2008-032267

(51) Int. Cl. G06K 9/34

(52) U.S. Cl. 382/177

(57) ABSTRACT

An image processing apparatus has a separation unit for separating objects constituting an image input by an image input unit, a setting unit for setting a criterion to determine whether or not a separated object is stored, and a determination unit for determining whether the separated object is stored based on the criterion set by the setting unit. The image processing apparatus also has a unit for displaying the separated object, responding to a user access via an interface unit, when the separated object is determined to be stored by the determination unit and storing the separated object such that the separated object can be reused.

### BACKGROUND OF THE INVENTION

1. Field of the Invention

The present invention relates generally to storing an image in a storage device, such as an image process to store an object separated from an image in a storage device so that the object can be easily used.

2. Description of the Related Art

Copy machines in recent years have become dramatically more sophisticated in terms of having more functions by the digitization of image processing. Copy machines available in recent years have included basic functions such as a copy function for copying an original document and a PDL function by which a document prepared by a host computer can be printed. Other functions can include a SEND function by which an original document is sent via a network to the exterior of a copy machine, a copy function, and a BOX function by which an original document image generated by a PDL function can be stored in the copy machine and can be reused. Recent copy machines also have numerous functions such as an edit function by which an original document image stored in the copy machine by the BOX function is used (e.g., synthesis, bookbinding).

Among such new techniques, a technique has been used to divide a read original document to region units, and to store the original document so that the document can be easily reused by the edit function. This technique divides the respective regions included in an original document to object regions (e.g., characters, photograph, and graphics) for example to store the object regions for the respective objects. The character and graphic regions are subjected to a vectorization and the resultant data is stored as vector data. The photo region is converted to JPEG data and the resultant data is stored and is used by the edit function (see Japanese Patent Laid-Open No. 2005-159517). According to this technique, without using bitmap data having of a very high information amount with a high resolution and a high bit number and by using vector data that can be easily edited and deformed, a reduced cost and an improved operability can be achieved to improve the image quality and the convenience. Regions judged as those other than character, photograph, and graphic regions are stored as a background object. The background region is a region that is used by the edit function with a low region and that is subjected to a JPEG compression with a higher compression rate than that of a photo region and the resultant data is stored.

When many users store objects in a disorderly manner, it can occur that the stored objects may not be capable of being reused efficiently.

To solve this, Japanese Patent Laid-Open No. 2006-146486 has suggested that an application (Copy, Send, FAX) and a format for the subsequent use can be selected with regard to the respective divided character, photograph, and graphic regions.

However, Japanese Patent Laid-Open No. 2006-146486 does not disclose that a certain object is judged with regard to whether the object is suitable for reuse or not, or that the judgment result is presented to a user. Thus, it can occur that an object that should be a background object may be inappropriately presented as a character, photograph, or graphic object to the user.

### SUMMARY OF THE INVENTION

According to one aspect of the present invention, an image processing apparatus is provided that includes a separation unit for separating objects constituting an image input by an image input unit, a setting unit for setting a criterion to determine whether a separated object is stored or not, and a determination unit for determining whether the separated object is stored or not based on the criterion set by the setting unit. The apparatus also includes a unit for displaying the separated object, responding to a user access via an interface unit, when the separated object is determined to be stored by the determination unit and storing the separated object such that the separated object can be reused.

Further features of the present invention will become apparent from the following description of exemplary embodiments (with reference to the attached drawings).

### BRIEF DESCRIPTION OF THE DRAWINGS

FIG. 1 is a block diagram illustrating an embodiment of an image processing system according to the present invention;

FIG. 2 is a block diagram illustrating an embodiment of a MFP as illustrated in FIG. 1;

FIG. 3 is a block diagram illustrating details of a data processing apparatus as illustrated in FIG. 2;

FIG. 4 is a flowchart illustrating an example of image processing flow according to aspects of the present invention;

FIG. 5 illustrates an example of a UI specifying a mode;

FIG. 6 is a flowchart illustrating an example of a scanning process;

FIG. 7 is a flowchart illustrating an example of a PC rendering;

FIG. 8 is a flowchart illustrating an embodiment of a general object separately storing process;

FIG. 9 is a flowchart illustrating an example of a printing process;

FIG. 10 illustrates an example of an object separation;

FIG. 11A illustrates an embodiment of block information of respective attributes obtained by object separation information;

FIG. 11B illustrates an embodiment of input file information obtained by object separation information;

FIG. 12 is a flowchart illustrating an example of a vectorization;

FIG. 13 illustrates an example of angle extracting in a vectorization;

FIG. 14 illustrates an example of contour line organizing in vectorization;

FIG. 15 is a flowchart illustrating an example of grouping of vector data generated in FIG. 12;

FIG. 16 is a flowchart illustrating an example of graphic form element detecting for vector data obtained by the grouping of FIG. 15;

FIG. 17 illustrates an example of a Scalable Vector Graphics (SVG) form described in an embodiment;

FIG. 18 is a flowchart illustrating an example of meta information;

FIG. 19 illustrates an example of a data map of a vectorization result;

FIG. 20 is a flowchart illustrating an example of application data conversion processing;

FIG. 21 is a flowchart illustrating details of an embodiment of a document tree structure generating in FIG. 20;

FIG. 22 illustrates an embodiment of a document subjected to document tree structure generating;

FIG. 23 illustrates an embodiment of a document tree structure generated in FIG. 21;

FIG. 24 illustrates an example of a UI display in Step S807 of FIG. 8;

FIG. 25 illustrates an example of a page display in UI display of Step S807 of FIG. 8;

FIG. 26 illustrates an example of an object attribute display in UI display of Step S808 of FIG. 8;

FIG. 27 illustrates an example of the display of one object subjected to object separation of UI display in Step S807 of FIG. 8;

FIG. 28 illustrates an example of a display of object and meta information of the UI display in Step S807 of FIG. 8;

FIG. 29 is a flow diagram illustrating an example of object separating and storing;

FIG. 30 is a flowchart illustrating an example of details of Step S2904;

FIG. 31 is a flow diagram illustrating an example of object separating and storing;

FIG. 32 is a flowchart illustrating an example of details of Step S3104; and

FIG. 33 illustrates an example of a UI that specifies an object separation level.

### DESCRIPTION OF THE EMBODIMENTS

A first embodiment of an image processing method according to aspects of the present invention will be described with reference to the drawings.

In Embodiment 1, a method for switching the storage method of an object depending on the property of the object will be described.

### [Image Processing System]

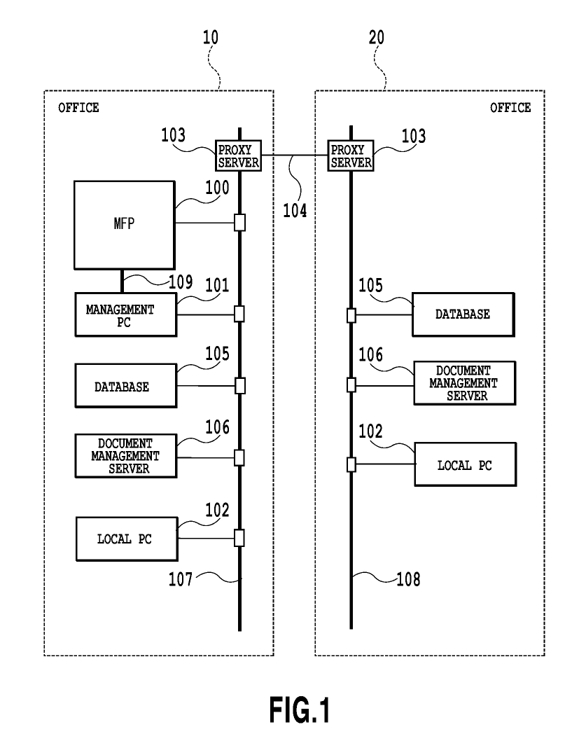

In FIG. 1, an example of an image processing system according to the embodiment is used in an environment in which an office 10 is connected to another office 20 via the Internet 104.

According to this embodiment, a LAN 107 structured in the office 10 is connected to a multifunction peripheral (hereinafter MFP) 100, a management PC 101 for controlling the MFP 100, a local PC 102, a document management server 106, and a database 105 for the document management server 106.

A LAN 108 is structured in the other office 20. The LAN 108 is connected to the document management server 106 and database 105 for the document management server 106.

The LAN 107 and the LAN 108 are connected to proxy servers 103. The LAN 107 and the LAN 108 are connected to the Internet via the proxy servers 103.

According to this embodiment, the MFP 100 is responsible for a part of an image processing of an input image read from an original document. The MFP 100 functions to input the image data of the processing result to a management PC 101 via a LAN 109. The MFP 100 also has a function to interpret a Page Description Language (hereinafter PDL) language sent from the local PC 102 or a general PC (not shown) to act as a printer.

The MFP 100 also has a function to send an image read from an original document to the local PC 102 or a general PC (not shown). The management PC 101 is a general computer that includes one or more of an image storage device, an image processing device, a display device, and an input device or the like. The functions of these constituting elements may be partially integrated to the MFP 100 to make up the image processing system. The MFP 100 may be directly connected to the management PC 101 via a LAN 109.

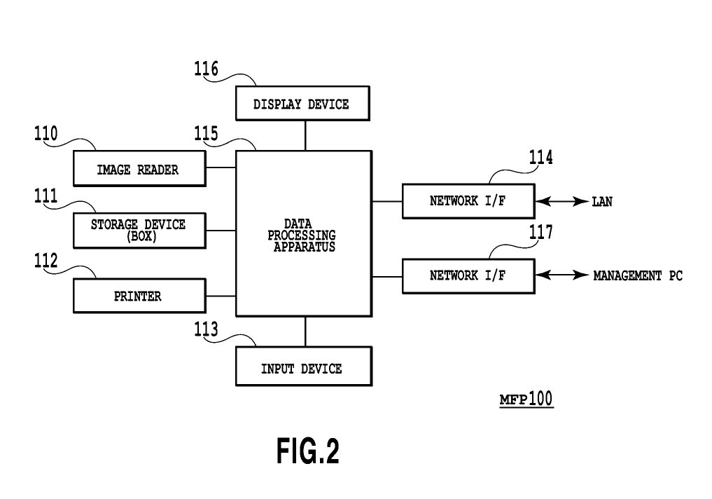

In the embodiment shown in FIG. 2, the MFP 100 includes an image reader 110 having an Auto Original document Feeder (hereinafter ADF) (not shown). The image reader 110 functions to allow an image of images of one or a plurality of original document in a bundle to be illuminated by light from a light source to image the reflected image on a CCD by a lens. The CCD generates an image signal of a predetermined resolution (e.g., 600 dpi) and a predetermined brightness level (e.g., 8 bit). Based on the image signal, image data of raster data is provided.

According to this embodiment, the MFP 100 has a storage device (hereinafter BOX) 111 and a printer 112. In order to carry out a general copy machine function, the MFP 100 may subject image data to an image copying process by the data processing apparatus 115 to convert the data to a recording signal to store and maintain the signal in the BOX 111. Thereafter, the MFP 100 may consecutively output the recording signal to the printer 112 to form a recording image on a printing paper.

The MFP 100 according to this embodiment has a network I/F 114 for the connection to the LAN 107. The MFP may use the printer 112 to record a PDL language outputted from the local PC 102 or other general PCs (not shown) via driver. The PDL data outputted from the local PC 102 via the driver is converted to a recordable recording signal by being sent from the LAN 107 via the network I/F 114 to the data processing apparatus 115 where the language is interpreted and processed. Thereafter, the converted recording signal may be recorded by the MFP 100 as a recording image on a printing paper.

The BOX 111 may have a function to store data from the image reader 110 and data obtained by rendering data outputted from the local PC 102 via a driver.

The MFP 100 may be operated through a key operation section provided in the MFP 100 (e.g., input device 113) or an input device of the management PC 101 (e.g., keyboard, pointing device). For the operation of the MFP 100, the data processing apparatus 115 uses an internal controller (not shown) to carry out a predetermined control.

The MFP 100 according to this embodiment has a display device 116. The display device 116 can display the status of an operation input and to-be-processed image data.

The BOX 111 may be directly controlled by the management PC 101 via a network I/F 117. The LAN 109 is used for the exchange of data and a control signal between the MFP 100 and the management PC 101.

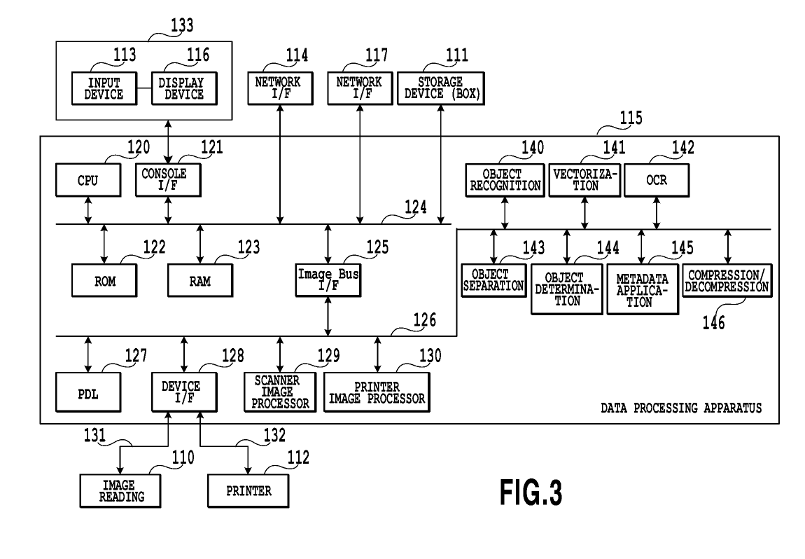

Next, the details of the embodiment of the data processing apparatus 115 of FIG. 2 will be described with reference to FIG. 3. The elements 110 to 117 of FIG. 3 are already described in the description of FIG. 2 and thus a part thereof will not be described further.

According to this embodiment, a data processing apparatus 115 is a control unit that comprises at least one of a CPU, a memory and the like, and is a controller for the input and output of image information and device information. The CPU 120 is a controller that controls the entire system. A RAM 123 is a system work memory for the operation of the CPU 120 and is also an image memory that temporarily stores image data. The ROM 122 is a boot ROM where a system boot program is stored. A console I/F 121 is an interface to the console 133 that outputs to the console 133 image data to be displayed on the console 133. The console I/F 121 also functions to send to the CPU 120 information inputted by a user of this image processing apparatus through the console 133. The devices as described above are provided on a system bus 124.

An image bus interface 125 according to this embodiment is a bus bridge that connects the system bus 124 to an image bus 126 transferring image data with a high speed to convert the data structure. The image bus 126 may comprise a PCI bus and an IEEE 1394, for example. On the image bus 126, the following devices may be arranged. A PDL processor 127 may analyze the PDL code to develop the code into a bitmap image. A device I/F section 128 may connect the image reader 110 as an image input/output device via a signal line 131 to the data processing apparatus 115 and may connect the printer 112 via a signal line 132 to the data processing apparatus 115 to subject the image data to a synchronous/asynchronous conversion. A scanner image processor 129 may subject the input image data to correction, processing, and editing. The print output image data to be outputted to the printer 112 may be subjected by a printer image processor 130 to correction, resolution conversion or the like in accordance with the printer 112.

According to this embodiment, an object recognition section 140 subjects the object separated by an object separation section 143 (which will be described later) to an object recognition processing (which will also be described later). A vectorization processor 141 subjects the object separated by the object separation section 143 to a vectorization (described below). An OCR processing (e.g., character recognition processing) section 142 subjects the object separated by the object separation section 143 to a character recognition processing (described further below). The object separation section 143 carries out an object separation (also described below). An object storage determination section 144 subjects the object separated by the object separation section 143 to a determination to determine whether the object is stored as an object or not (described below). A metadata assignment section 145 assigns metadata to the object separated by the object separation section 143 (described in further detail below). A compression/decompression section 146 subjects the image data to a compression/decompression in order to more efficiently use the image bus 126 and the printer 112.

### [Entire Flow]

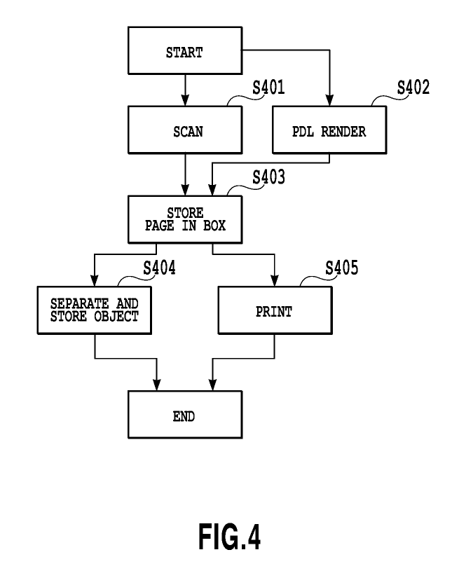

FIG. 4 is a flowchart of processing according to this embodiment. The processing shown in FIG. 4 may be executed by the CPU of and image processing system according to aspects of the present invention.

Step S401 allows the image reader 110 to obtain the bitmap image to subject the data to scanned image processing by the data processing apparatus 115. In this process, the data processing apparatus 115 may mainly use the scanner image processor 129 and a compression/decompression section 146.

In Step S402, a document prepared by application software on the local PC 102 is received via the network I/F 114 by the MFP 100, and is rendered by the data processing apparatus 115 to generate a bitmap image. In this process, the data processing apparatus 115 may mainly use the PDL processor 127 and the compression/decompression section 146. As described above, an image can be inputted by a method for inputting a scanned image and a method for inputting an image prepared by application software on a local PC via a network.

In Step S403, the bitmap image generated in Step S401 or Step S402 is stored in the BOX 111 on the basis of a page.

In Step S404, the data processing apparatus 115 subjects the bitmap image stored in Step S403 to an object separation processing and the resultant data for the respective objects is stored in the BOX 111. In this process, the data processing apparatus 115 may mainly use the object recognition section 140, the vectorization processor 141, the OCR (optical character recognition) processing section 142, the object separation section 143, the object storage determination section 144, the metadata assignment section 145, and the compression/decompression section 146.

Step S405 is a step to print the data stored in the BOX. In Step S405, the data stored in the BOX 111 is subjected by the data processing apparatus 115 to a print image processing and the to-be-printed image data is outputted to the printer 112 to record the image as a recorded image on a printing paper. In this process, the data processing apparatus 115 mainly uses the printer image processor 130 and the compression/decompression section 146.

### [Storing Into BOX Simultaneously With Print Out in Copy Mode]

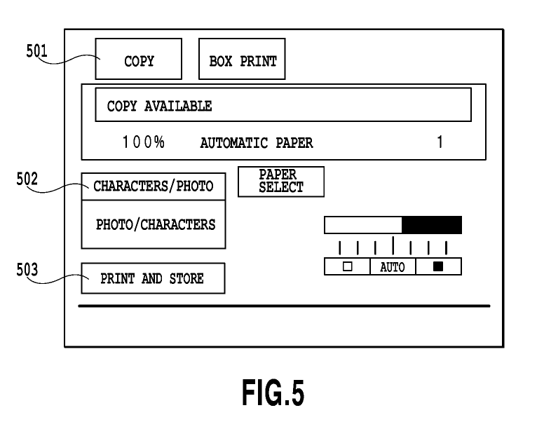

FIG. 5 shows an example of a control panel screen attached to the MFP 100.

According to this example, when a user depresses a button 501, then a copy can be printed and outputted by allowing the user to use a button 502 to select an original document type to be printed and outputted as a copy. In FIG. 5, the original document type is shown to include “characters/photo”, “photo”, and “characters”. In the case of the “characters/photo”, data of an original document including characters and a photo is subjected to an optimal image processing for the respective objects to copy the document. Specifically, a character region is separated from a photo region, and the character region is subjected to a character image processing and the photo region is subjected to a photo image processing. In the case of “photo”, the data is subjected to an image processing optimal for the photograph. In the case of “characters”, the data is similarly subjected to an image processing optimal for the characters.

Next, a button 503 will be described. When this button is depressed, the processes of Steps S401, S403, S404, and S405 of FIG. 4 are carried out, and the print is outputted simultaneously with the storage of the image data to the BOX 111.

### [Storing Data Into BOX Simultaneously With PDL Print Out]

The PDL print output also can be executed simultaneously with the BOX storage. In this case, the processes of Steps S402, S403, S404, and S405 of FIG. 4 are carried out and the print output is carried out simultaneously with the storage of the image data to the BOX 111.

### [Generation of Bitmap Image Data Using Image Readier (Step S401)]

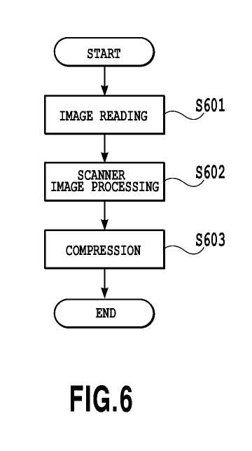

FIG. 6 is a flowchart illustrating an example of the details of Step S401.

When the image reader 110 of the MFP 100 is used, Step S601 allows the image reader 110 to read the image. The read image may already be a bitmap image data.

Step S602 subjects the bitmap image data to image processing depending on a scanner. The image processing mainly includes the two processes of: 1) color processing optimal to the scanner; and 2) filter processing. Two types of filters may be prepared in order to subject the respective original document types to an optimal processing. Specifically, a filter for subjecting characters to an optimal high edge enhancement and a filter for subjecting photo data to an optimal smoothing may be used depending on the original document type.

Step S603 subjects the bitmap image to a compression. In this case, the bitmap image is subjected to a JPEG compression. In the compression, the compression coefficient maybe adjusted so that the image has a size smaller than the specified image size. This compression process may remarkably deteriorate some images.

### [Generation of Bitmap Image Data Using Print Data (Step S402)]

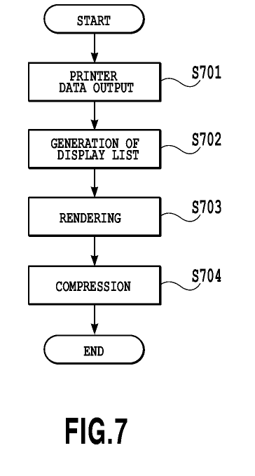

FIG. 7 is a flowchart illustrating an example of the details of Step S402.

The application data prepared using the application software on the PC 102 is converted in Step S701 by the print driver on the PC 102 to print data and the resultant data is sent to the MFP 100. The term “print data” herein may mean PDL, including for example LIPS® and Postscript®.

Next, in Step S702, a display list is generated via an interpreter existing in the MFP 100.

In Step S703, the display list is rendered to generate bitmap image data.

In Step S704, the bitmap image is subjected to a compression. In this case, the bitmap image is subjected a JPEG compression. In the compression process, the compression coefficient maybe adjusted so that the image has a size smaller than the specified image size. This compression process may remarkably deteriorate some images.

### [Separating and Storing Object (Step S404)]

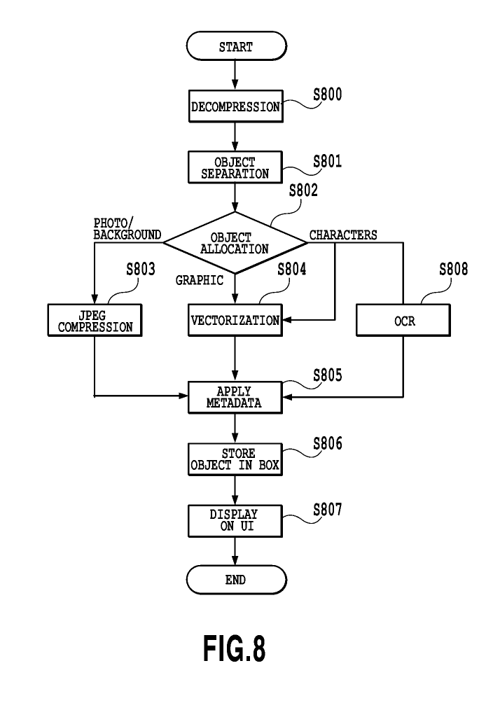

FIG. 8 is a flowchart illustrating examples of the details of Step S404.

First, in Step S800, the bitmap image compressed stored in S403 is decompressed. The decompression may be executed using a decompression coefficient corresponding to the compression coefficient used in the compression. Next, Step S801 carries out the object separation to divide objects into, for example, one or more of a character object, a photo object, a graphics object (graphic, line, table), and a background object.

The respective divided objects of bitmap data are subjected by Step S802 to different processes depending on the types of the objects (e.g., characters, photograph, graphics, and background) If the object is a photo object or a background object (PHOTO/BACKGROUND in step S802), processing proceeds to step S803. A photo object of bitmap data is subjected by Step S803 to a JPEG compression. A background object of bitmap is similarly subjected by Step S803 to a JPEG compression. Next, when the object determination results in a graphic object (GRAPHIC in step S802), processing proceeds to step S804 where the graphic object is subjected to a vectorization to convert the data to data subjected to a pathing process. When the object determination results in a character object (CHARACTERS in step S802), processing proceeds to both steps S804 and S808. In step S804, the character object is subjected to a vectorization as in the graphic object to convert the data to data subjected to a pathing process. The character object is further subjected by Step S808 to an OCR processing (character recognition processing) to convert the data to character-coded data. All of the object data and character-coded data are stored in a single file.

Next, Step S805 gives optimal metadata to the respective objects. The respective objects given with the metadata are stored by Step S806 in the BOX 111. The stored data is displayed by Step S807 on a UI screen, and processing is ended.

### [Print Processing (Step S405)]

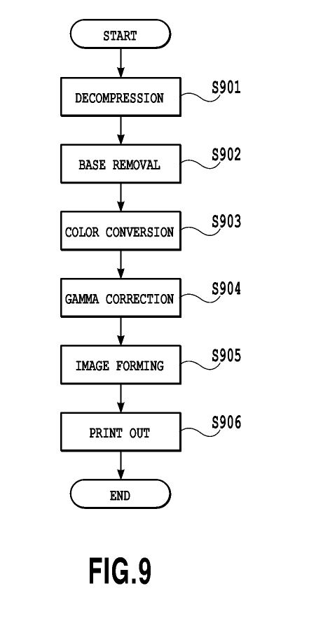

FIG. 9 is a flowchart illustrating an example of the details of Step S405.

First, Step S901 decompresses the compressed bitmap image stored in S403. The decompression may use a decompression coefficient corresponding to the compression coefficient used in the compression. The decompressed image data is subjected by Step S902 to a background color removal. Next, Step S903 subjects the data to a color conversion. This color conversion converts RGB image data to CMYK image data. Next, Step S904 subjects the respective colors of C, M, Y, and K to a gamma correction processing. Next, Step S905 subjects the data to an image forming and Step S906 outputs a print.

### [Object Separating Step (Details of Object Separating and Storing)]

A region division technique may be used to carry out an object separation. An example will be described.

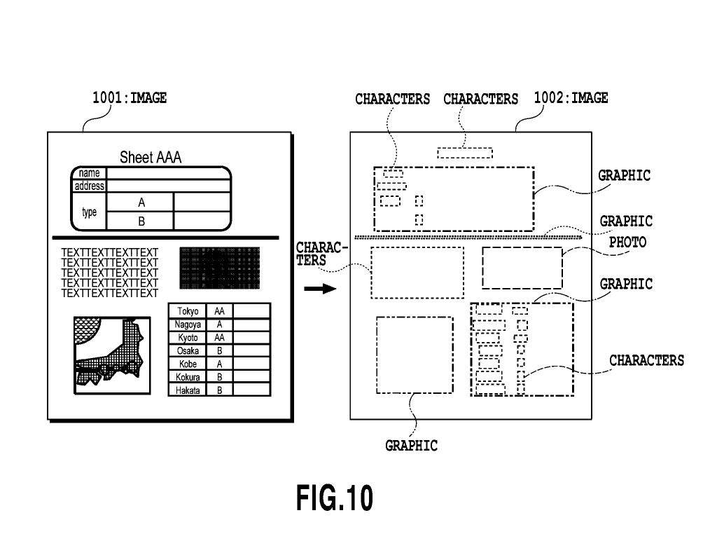

In Step S801 (object separating step) of FIG. 8, as shown in an image 1002 at the right side of FIG. 10, an input image 1001 is divided to rectangular blocks based on the respective attributes. As described above, the rectangular blocks have attributes such as character, photograph, and graphic (e.g., graphic, line, table) attributes.

In one version of the object separating Step, image data stored in a RAM (not shown) is first binarized to white and black data to extract a pixel block surrounded by a contour formed by black pixels.

Then, the size of the extracted black pixel block is evaluated. The contour of a white pixel block within a black pixel block having a size equal to or higher than a predetermined value is tracked. Next, so long as the inner pixel block has a value equal to or higher than the predetermined value, the pixel block is extracted and the contour is tracked recursively by evaluating the size to the white pixel block and by tracking the contour of the inner black pixel block.

The size of the pixel block may be evaluated based on the area of the pixel block, for example.

A rectangular block circumscribed with the pixel block thus obtained is generated to determine the attribute based on the size and shape of the rectangular block.

For example, in the case of a rectangular block having an aspect ratio close to 1 and the size within a fixed range, the rectangular block is judged as a character corresponding block for which the rectangular block may be a rectangular character region block. Then, when neighboring character corresponding blocks are arranged regularly, a new rectangular block obtained by collecting these character corresponding blocks is generated to use the new rectangular block as a rectangular character region block.

A flat pixel block or a black pixel block in which circumscribed rectangles of white pixel blocks having a fixed size or more and a square shape are arranged without being superposed on one another is assumed as a rectangular graphic region block. A pixel block having various shapes other than the above ones is assumed as a rectangular photo region block.

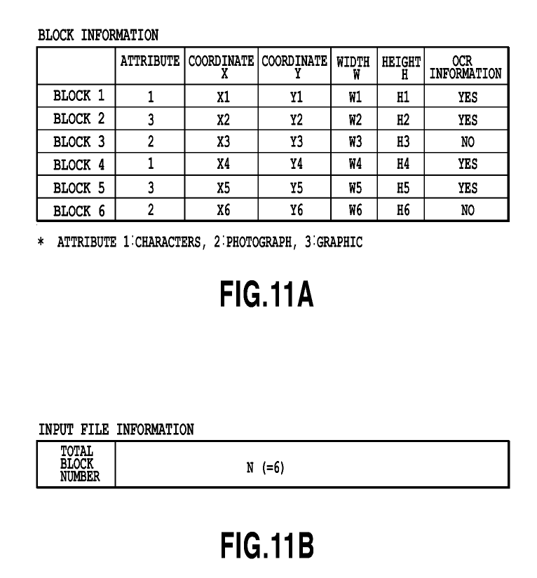

The object separating step generates, with regard to the respective rectangular blocks thus generated, block information such as attributes as shown in FIG. 11A and the input file information as shown in FIG. 11B.

In the object separating step, with regard to the respective rectangular blocks thus generated, the block information and the input file information, such as attributes as shown in FIG. 11A and FIG. 11B may be generated.

In the example shown in FIG. 11A, the block information includes the attributes of the respective blocks, position coordinate X, coordinate Y, width W, height H, and OCR information. An attribute is given by a numeric value from 1 to 3. An attribute 1 represents a rectangular character region block. An attribute 2 represents a rectangular photo region block. An attribute 3 represents a rectangular graphic region block. The coordinate X and coordinate Y are coordinates X and Y (coordinates at an upper left corner) at origins of the respective rectangular blocks in an input image. The width W and height H represent the width in the direction of the coordinate X and the height in the direction of the coordinate Y of a rectangular block. The OCR information represents the existence or nonexistence of pointer information in an input image.

The input file information shown in the example of FIG. 11B includes a total block number N showing the number of rectangular blocks.

The block information for the respective rectangular blocks may be used for the vectorization in a specific region. The block information also can be used to recognize the relative positional relation between the specific region and other regions in order to synthesize the former with the latter. Thus, the vectorization region can be synthesized with the raster data region without damaging the layout of the input image.

### [Vectorization Step (Details of Separating and Storing Object)]

A vectorization technique may be used to carry out vectorization, an example of which will be described.

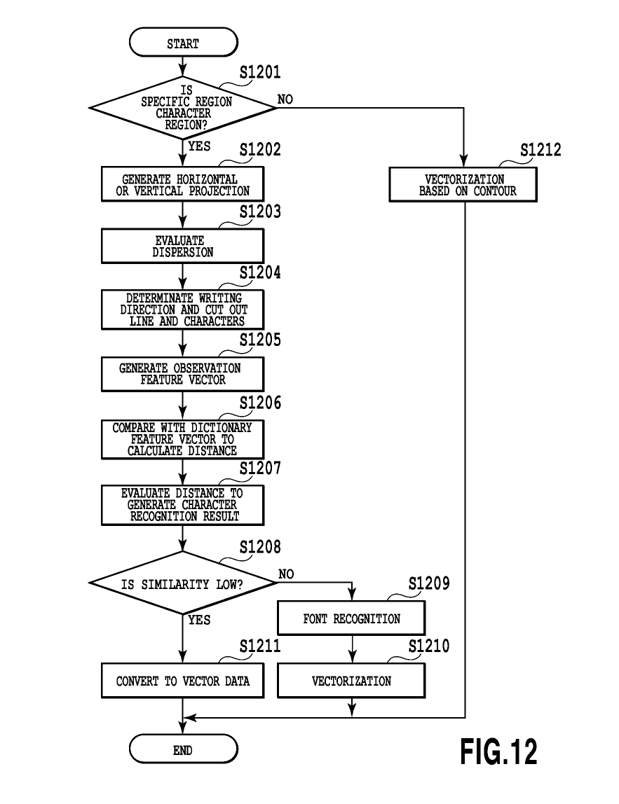

Step S804 (vectorization Step) of FIG. 8 may be carried out by the respective steps in the example shown in the flowchart of FIG. 12.

Step S1201 determines whether a specific region is a rectangular character region block or not. When the specific region is a rectangular character region block (YES in step S1201), then the processing proceeds to steps after Step S1202 to use a pattern matching method to carry out the character recognition to obtain the corresponding character code. When the specific region is not a rectangular character region block (NO in step S1201), then the processing proceeds to Step S1212.

Step S1202 determines the specific region with regard to whether the region is a horizontal writing region or a vertical writing region (e.g., determination of writing direction) by obtaining horizontal and vertical projections to the pixel value within the specific region.

Step S1203 evaluates the dispersion of the projection of Step S1202. When the horizontal projection has a high dispersion, the region is determined as a horizontal writing. When the vertical projection has a high dispersion, then the region is determined as a vertical writing.

Based on the evaluation result of Step S1203, Step S1204 determines the writing direction to determine the writing direction to cut out a line. Thereafter, characters are cut out to obtain character images.

The disassembly of the lines into characters strings and characters are performed, in the case of the horizontal writing, the projection in the horizontal direction is used to cut out a line to cut out characters based on the projection of the line in the vertical direction. A character region of the vertical writing is subjected to opposite processings with regards to the horizontal and vertical directions. Detection of lines and characters also may detect a character size.

Step S1205 generates, with regard to characters cut out in Step S1204, a observation feature vector obtained by converting a feature obtained from a character image to a numerical string of dozen of dimensions. A feature vector may be extracted by various known methods, including a method to divide a character in a mesh-like manner to count character lines in each mesh based on each direction as linear elements to assume a vector of a few dimensions as the linear elements as a feature vector.

Step S1206 compares the observation feature vector obtained in Step S1205 with a dictionary feature vector previously calculated based on the respective font types to calculate the distance between the observation feature vector and the dictionary feature vector.

Step S1207 evaluates the distance calculated in Step S1206 to determine the type of a font having the shortest distance as a recognition result.

Step S1208 determines, with regard to the distance evaluation in Step S1207, whether the shortest distance is longer than a predetermined value or not to determine the similarity. When the similarity is equal to or higher than the predetermined value, there is a high probability where a wrong character having a similar shape is mistakenly recognized in the dictionary feature vector. Thus, when the similarity is equal to or higher than the predetermined value (YES in step S1208), the recognition result of Step S1207 is not used to proceed to the processing of Step S1211. When the similarity is lower or smaller than the predetermined value (NO in step S1208), then the recognition result of Step S1207 is used to proceed to Step S1209.

Step S1209 (font recognition Step); the data processing apparatus 115 has a plurality of dictionary feature vectors corresponding to the font types used in the character recognition with regard to the character shape types (i.e., font types). The pattern matching may use this dictionary feature vector to output a character code and a font type to recognize the character font.

Step S1210 uses the character code and font information obtained in the character recognition and font recognition to use the respective previously-prepared outline data to convert the respective characters to vector data, after which the processing is ended. When the input image is a color image, the colors of the respective characters are extracted from the color image to record the colors and the vector data.

Step S1211 handles characters like general graphics to provide the characters with an outline, after which the processing is ended. Specifically, with regard to a character that may be mistakenly recognized with a high probability, vector data having an outline directly based on image data in a visible manner is generated.

Step S1212 carries out, when the specific region is not a rectangular character region block, the vectorization based on the contour of the image, after which the processing is ended.

Through the processes as described above, the image information corresponding to the rectangular character region block can be converted to vector data having substantially-correct shape, size, and color.

### [Vectorization of Graphic Region (Details of Separating and Storing Object)]

When it is determined that a block separated in Step S801 (FIG. 8) is a region other than the rectangular character region block (i.e., rectangular graphic region block), the contour of the black pixel block extracted in the specific region is converted to the vector data.

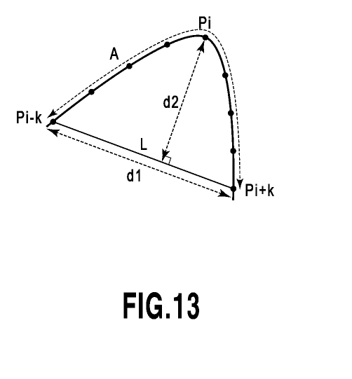

In the vectorization of a region other than a character region, a line or the like may be represented by a combination of a straight line and/or a curve by detecting “angles” at which a curve is divided to a plurality of intervals (pixel strings). The angle means a point at which the curvature is maximum. An example of the determination with regard to whether the pixel Pi on the curve of FIG. 13 is the angle or not may be carried out in the manner as described below.

Specifically, pi is assumed as an origin and it is assumed that pixels Pi−k and Pi+k separated from each other by a predetermined number of pixels (in an amount of “k”) are arranged in both directions from Pi along a curve and are connected by a line segment L. When assuming that the distance between the pixels Pi−k and Pi+k is d1, the distance between the line segment L and the pixel Pi is d2, and the length of an arc between the pixels Pi−k and Pi+k of the curve is A and when d2 is maximum or the ratio (d1/A) is equal to or lower than a threshold value, then the pixel Pi is determined as the angle.

The pixel string divided by the angle is approximated by a straight line or a curve. The approximation to a straight line is executed by the least-square method for example. The approximation to a curve uses the cubic spline function for example. A pixel at an angle at which a pixel string is divided functions as a start end or a finish end in an approximation straight line or an approximation straight line.

Next, whether the inner contour of the white pixel block exists in the vectorized contour or not is determined. When the inner contour exists, the contour is vectorized. Then, the inner contour of the inverted pixel is recursively vectorized by vectorizing the inner contour of the inner contour for example.

As described above, the approximation of the section line of the contour can be used to vectorize the outline of a graphic form having an arbitrary shape. When the original document is a color document, then the color of the graphic form is extracted from the color image to record the color together with the vector data.

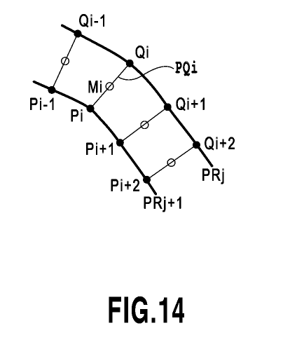

As shown in the example of FIG. 14, when the outer contour PRj is close to the inner contour PRj+1 or another outer contour in a certain target interval, then two or a plurality of contour lines can be collected to a single group to represent the group as a line having a thickness. For example, the distance PQi as the shortest distance from each pixel Pi of the contour pj+1 to the pixel Qi on the contour PRj is calculated. When the dispersion of PQi is small, then the target interval may be approximated by a straight line or a curve along a dot sequence of a midpoint Mi of pixels Pi and Qi. The thicknesses of the approximation straight line and the approximation curve are an average value of the distance PQi for example.

Tables and ruled lines composed of lines and the collection of lines can be represented by a vector by being recognized as a collection of lines having a thickness.

After the processing of collecting the contour, the entire processing may be completed.

The rectangular photo region block may not be vectorized and may be directly used as image data.

### [Graphic Recognition (Details of Separating and Storing Object)]

After the vectorization of the outline of lines and graphics, the vectorized section line maybe grouped with regard to each a graphic object.

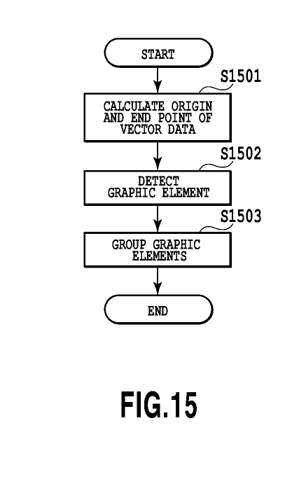

The respective steps in the example of processing illustrated in FIG. 15 show processes to group vector data with regard to each graphic object.

Step S1501 first calculates the origin and end point of each vector data.

Step S1502 uses the information for the origin and endpoint calculated in Step S1501 to detect the graphic element. The graphic element may be a closed graphic composed of section lines. The graphic element may be detected by connecting vectors of pixels of a common angle of the origin and the final end. Specifically, a principle may be used according to which the respective vectors constituting a closed shape have connecting vectors at both ends thereof.

Next, Step S1503 groups other graphic elements or section lines existing in the graphic element to assume the graphic elements or section lines as one graphic object. When no graphic elements or section lines exist in the graphic element, then the graphic elements may be assumed as a graphic object.

### [Detection of Graphic Element (Details of Separating and Storing Object)]

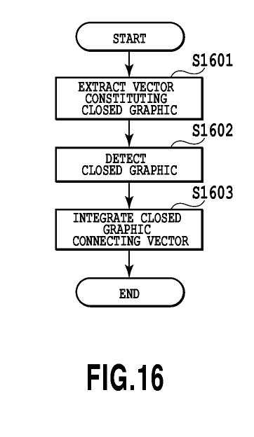

An example of the processing of Step S1502 (detection of graphic element) is executed by the respective steps shown in the processing of FIG. 16.

Step S1601 first uses the vector data to remove an unnecessary vector not connecting at both ends to extract a vector constituting a closed graphic.

Next, Step S1602 assumes, with regard to vectors constituting a closed graphic, any end point (origin or end point) of the vector as a start point to consecutively search vectors in a fixed direction (e.g., clockwise direction). Specifically, Step S1602 searches end points of other vectors in other end points to assume the closest end point within the predetermined distance as an end point of a connecting vector. When vectors of the closed graphic are all searched to return to the start point, then all of the searched vectors are grouped as a closed graphic constituting one graphic element. All of vectors constituting the closed graphic in the closed graphic are also grouped. Then, the origin of the not-yet-grouped vector is assumed as a start point to repeat the same processing.

Finally, Step S1603 detects, from among the unnecessary vectors removed in Step S1601, a vector having an end point close to vectors grouped as a closed graphic in Step S1602 to group the vectors as one graphic element.

Through the example of processing as described above, the graphic block can be handled as an individual graphic object that can be reused.

### [Detailed Setting of Registration (Details of Separating and Storing Object)]

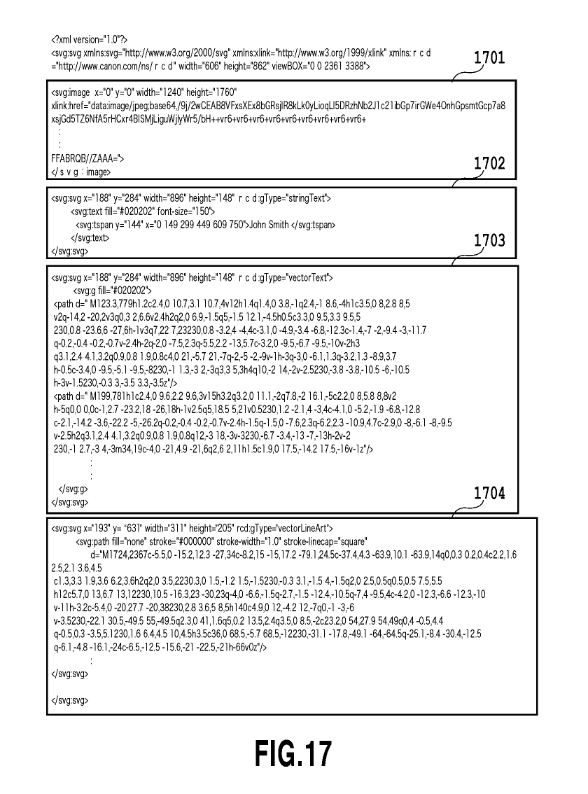

An example of the format of the data vectorized by the vectorization of Step S804 (FIG. 8) is shown in FIG. 17. Although the format is shown by the SVG form in this embodiment, the format is not limited thereto.

For description, FIG. 17 shows the objects surrounded by frames. The frame 1701 represents an image attribute. In the frame 1701, the region information showing the region of the image object and the bitmap information are shown. The frame 1702 represents the information of a text object. The frame 1703 represents the contents shown by the frame 1702 as a vector object. The frame 1704 represents a line art such as a table object.

### [Metadata Application (Details of Separating and Storing Object)]

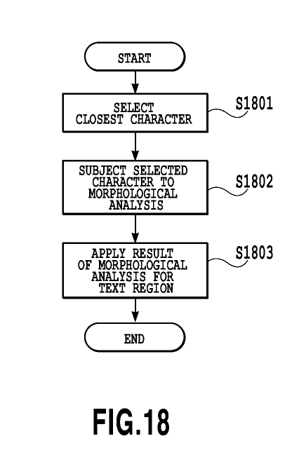

FIG. 18 shows a flowchart illustrating an example of the application of metadata of Step S805.

First, Step S1801 selects a character object around the object that exists at a position closest to the object. Next, Step S1802 subjects the selected character object to a morphological analysis. A word extracted by the result of the morphological analysis is assumed as metadata. Step S1803 applies the metadata to the respective objects, after which the processing may be ended.

Metadata can be prepared not only by the morphological analysis but also by the extraction of the image feature amount or a syntax analysis for example.

### [BOX Storing (Details of Separating and Storing Object)]

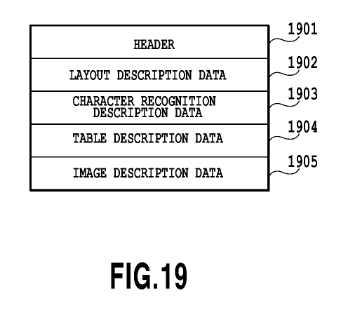

After the object separating step (Step S801) of FIG. 8, the data of the result of the vectorization (Step S804) may be used to convert the data to data to be stored in the BOX. The result of the vectorization of Step S804 may be stored in a so-called document analysis output format (hereinafter, DAOF) as an intermediate data form as shown in the example in FIG. 19.

In the example shown in FIG. 19, the DAOF is composed of a header 1901, a layout description data section 1902, a character recognition description data section 1903, a table description data section 1904, and an image description data section 1905.

The header 1901 retains the information regarding the input image as a processing target.

The layout description data section 1902 retains information (e.g., characters, line, diagram, table, photograph) as attributes of rectangular blocks in an input image and the information for the positions of the respective rectangular blocks for which these attributes are recognized.

The character recognition description data section 1903 retains the character recognition result obtained by recognizing characters in the rectangular character region block.

The table description data section 1904 stores therein the details of the table structure of the rectangular graphic region block having a table attribute.

The image description data section 1905 retains the image data in the rectangular graphic region block cut out from the input image data.

With regard to a block in a specific region for which the vectorization is instructed, the image description data section 1905 retains the data collection (e.g., data representing the block inner structure obtained by the vectorization, the image shape, or a character code).

On the other hand, with regard to a rectangular block other than a specific region not subjected to the vectorization, the input image data itself may be retained.

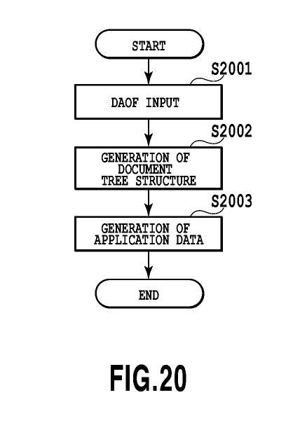

The processing of the conversion to the BOX storage data may be executed by the respective steps in the example of processing illustrated in FIG. 20.

Step S2001 inputs DAOF form data.

Step S2002 generates the document tree structure functioning as a base of application data.

Step S2003 obtains, based on the document tree structure, actual data in the DAOF to generate actual application data.

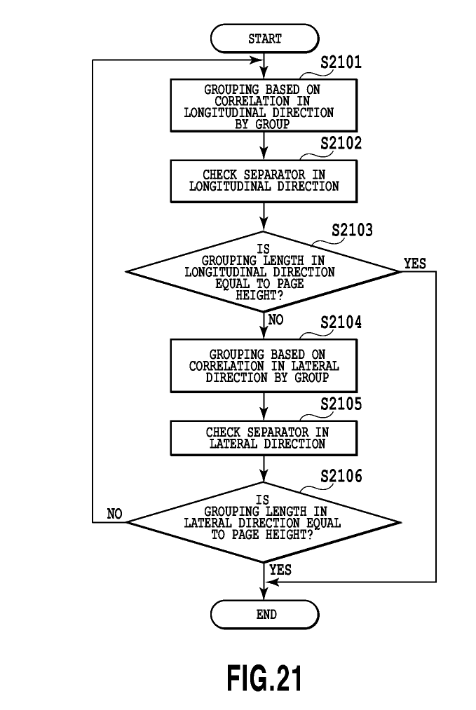

The processing of Step S2002 of generating the document tree structure may be carried out by the respective steps in the example of processing illustrated in FIG. 21. The entire control in the example of processing in FIG. 21 has a basic rule according to which the processing flows from a microblock (single rectangular block) to a macroblock (collection of rectangular blocks). Hereinafter, the “rectangular block” is assumed to mean both of the microblock and macroblock.

Step S2101 groups the rectangular blocks again based on the correlation of the rectangular blocks in the longitudinal direction. Although the processing of FIG. 21 may be executed repeatedly, the correlation may be determined based on a microblock just after the start of the processing.

The correlation is defined by features such as a short distance, the substantially same block width (or height in the lateral direction). The information for a distance, width, height or the like is extracted by referring to DAOF.

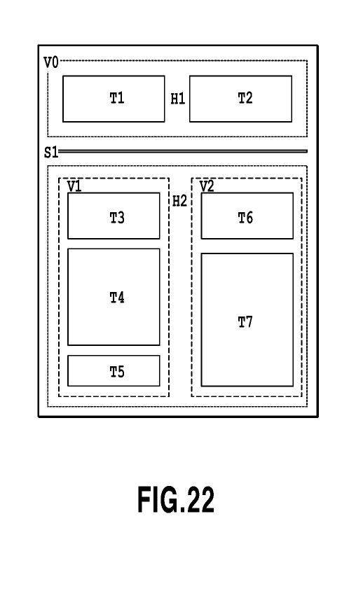

In the case of the example of image data shown in FIG. 22, rectangular blocks T1 and T2 are arranged at the uppermost section in the lateral direction. Under the rectangular blocks T1 and T2, a lateral separator S1 exists. Under the lateral separator S1, rectangular blocks T3, T4, T5, T6, and T7 exist.

The rectangular blocks T3, T4, T5 are arranged in the left-half section in the lower region of the lateral direction separator S1 in the longitudinal direction from the top to the bottom. The rectangular blocks T6 and T7 are arranged in the right-half section in the lower region of the lateral direction separator S1.

Returning to FIG. 21, based on the correlation in the longitudinal direction of Step S2101, the grouping is executed. As a result, the rectangular blocks T3, T4, and T5 are grouped into one group (rectangular block) V1 and the rectangular blocks T6 and T7 are grouped to one group (rectangular block) V2. The groups V1 and V2 are in the same hierarchical layer.

Step S2102 checks the existence or nonexistence of the longitudinal separator. The separator is an object that has a line attribute in DAOF and that has a function to explicitly divide a block in application software. When the separator is detected, a region of an input image in a hierarchical layer as a processing target is divided to left and right parts from the separator as a boundary. In the example shown in FIG. 22, no longitudinal separator exists.

Step S2103 determines whether the total of group heights in the longitudinal direction is equal to the height of the input image or not. Specifically, when the regions as a processing target are grouped in the lateral direction while checking the regions in the longitudinal direction (e.g., from the top to the bottom) and when the processing of the entire input image is completed, then the total of the group height equals to the height of the input image. This result is used to determine whether the processing is completed or not. When the grouping is completed (YES in step S2103), then the processing is completed. When the grouping is not completed (NO in step S2103), then the processing proceeds to Step S2104.

Step S2104 carries out the grouping based on the correlation in the lateral direction. As a result, the rectangular blocks T1 and T2 are grouped into one group (rectangular block) H1 and the rectangular blocks V1 and V2 are grouped into one group (rectangular block) H2. The groups H1 and H2 are in the same hierarchical layer. In this case, the determination is similarly made based on a micro block just after the start of the processing.

Step S2105 checks the existence or nonexistence of a separator in the lateral direction. When a separator is detected, then the region of the input image in the hierarchical layer as a processing target is divided to upper and lower parts from the separator as a boundary. In FIG. 22, the separator S1 in the lateral direction exists.

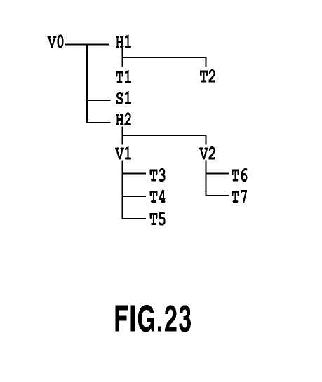

The result of the processing as described above is registered as a tree in the example illustrated in FIG. 23.

In the example illustrated in FIG. 23, with regard to the input image V0, the highest hierarchical layer has the groups H1 and H2 and the separator S1 and the group H1 has the rectangular blocks T1 and T2 in the second hierarchical layer.

The group H2 has the groups V1 and V2 in the second hierarchical layer. The group V1 has the rectangular blocks T3, T4, and T5 in the third hierarchical layer. The group V2 has the rectangular blocks T6 and T7 in the third hierarchical layer.

Step S2106 determines whether the total of the group length in the lateral direction is equal to the width of the input image. Based on this, the final decision on the grouping in the lateral direction is made. When the group length in the lateral direction is equal to the page width (YES in step S2106), then the processing for generating the document tree structure is completed. When the group length in the lateral direction is not equal to the page width (NO in step S2106), the processing returns to Step S2101 to start the process of checking the correlation in the longitudinal direction again in a hierarchical layer that is higher than the previous hierarchical layer by one hierarchical layer.

### [Display Method (Details of Separating and Storing Object)]

The processing in the example shown in FIG. 8 for the display on UI (S807) will be described in detail.

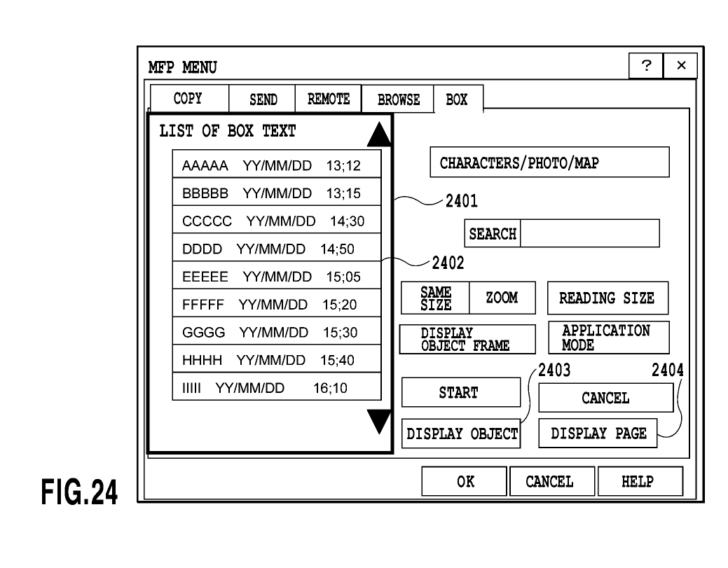

FIG. 24 illustrates an example of a user interface used when the user accesses the BOX. FIG. 24 illustrates the display of the data stored in the BOX (2401). Every text has a name and is displayed with information showing the time at which the text was inputted (2402). When separated objects are displayed, then an original document is selected from the list 2401 to depress the object display button 2403 to change the display, as described below. An original document is also selected from the list 2401 to depress the page display button 2404 to change the display, as is also described below.

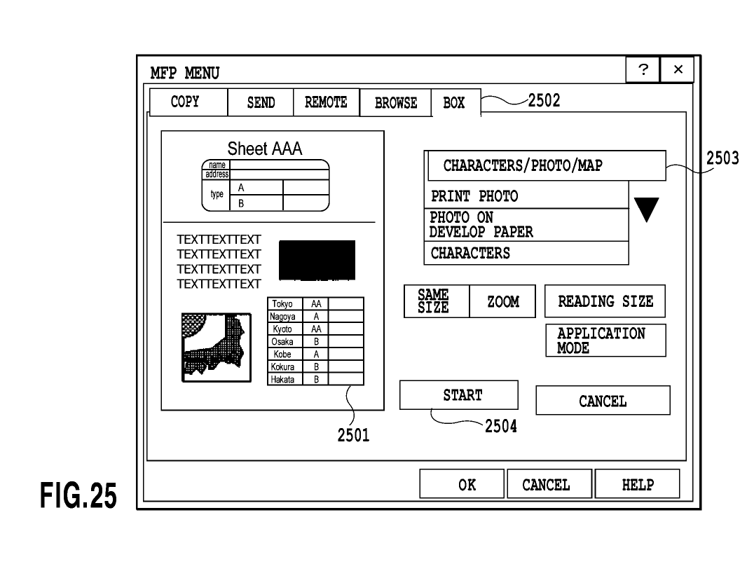

FIG. 25 shows an example of a user interface used when the user accesses the BOX. The object 2501 of FIG. 25 shows data stored in the processing of Step S806 of FIG. 8. An image obtained by reducing the size of a raster image also can be displayed or a display using the above-described SVG also can be executed. Specifically, the entire page may be displayed based on the above-described data. By selecting a tab 2502, a function provided in the MFP (e.g., copy, send, remote operation, browser, BOX) can be selected. Functions other than the above functions also can be similarly displayed. A selection box 2503 also can be used to select an original document mode used to read the original document. This selection selects a mode in order to switch the image processing depending on the type of the original document. Modes other than the above modes also can be selected for display. By depressing the original document reading start button 2504, a scanner is caused to operate to read the image. Although this example provides the reading start button 2504 in the screen, the reading operation also may be started by another start button.

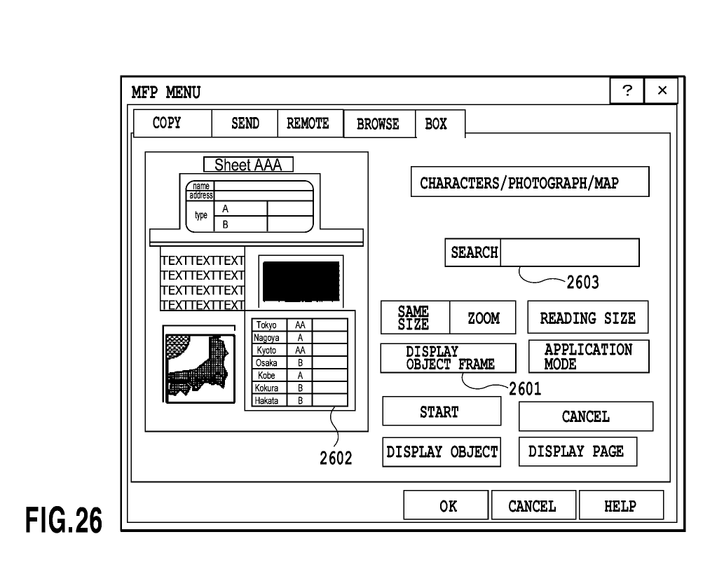

The example of the user interface illustrated in FIG. 26 displays frames for the respective objects so that the result of the object separation can be found. By depressing a button 2601, the respective object frames are displayed in the page display screen 2602. By coloring the frames, the frames are displayed so that the difference of the objects can be found or the difference of the objects can be displayed by the thickness of the line or the use of a dot line and a broken line. The object types are characters, diagram, line, table, photograph or the like as described above. A search box 2603 is an input section to which characters for carrying out search is inputted. When the user accesses the search box 2603 to input a character string to the search box 2603 to search the character string, the object or a page including the object is searched. The search of the object or page is carried out by using the above-described metadata to use a well-known search method. Then, the searched object or page is displayed.

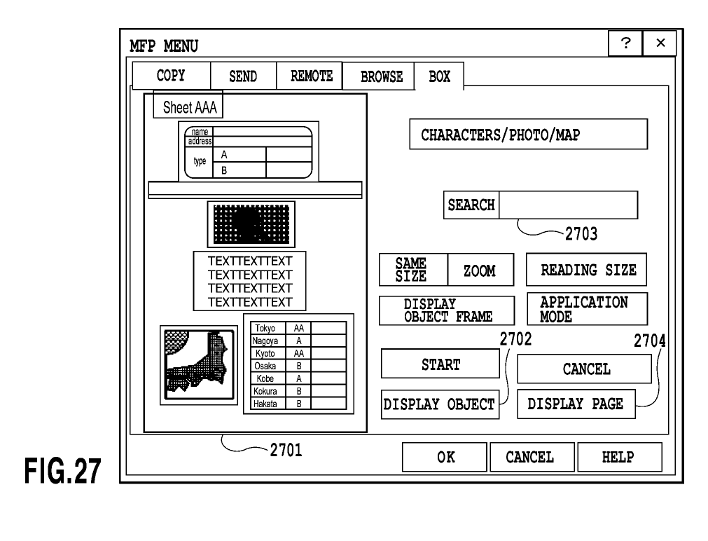

The example of the user interface illustrated in FIG. 27 is displayed to show the object in a page when the object display button 2702 is depressed. This page is not based on a concept of page and shows every object as a part (2701). By depressing the page display button 2704, the display is switched so that an image of one page also can be displayed. The search box 2703 is an input section to which characters for search are inputted. When the user accesses the search box 2703 to input a character string to the search box 2703 for search, an object or a page including the object is searched. The search of the object or page is carried out by using the above-described metadata to use a search method. Then, the searched object or page is displayed.

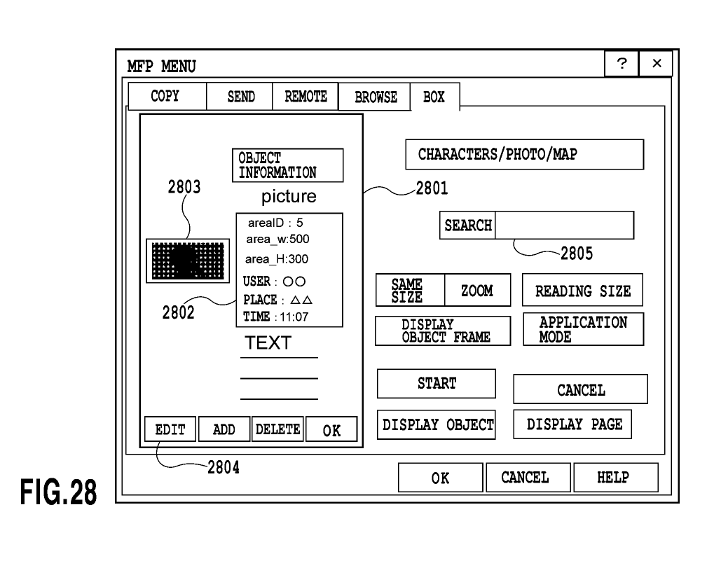

FIG. 28 shows an example of a user interface screen that displays the metadata of an object. When a certain object is selected, then the image 2803 of the object and the above-described metadata 2802 are displayed (2801). The metadata displays additional information such as the area information, width, height, user information, and information of a place where the MFP is provided. In this example, based on the OCR information of the character object close to the object having a picture attribute, the morphological analysis is used to extract only a noun to display the noun. This noun corresponds to the shown character string TEXT. Data can be added to or can be deleted from the metadata 2802 or the metadata 2802 can be edited by using various buttons 2804. The search box 2805 is an input section to which characters for search are inputted. When the user accesses the search box 2805 to input a character string to the search box 2805 for search, the object or a page including the object is searched. The search of the object or page is carried out by using the above-described metadata to use a search method. Then, the searched object or page is displayed.

### [Separating and Storing Object in the Embodiment (Step S404)]

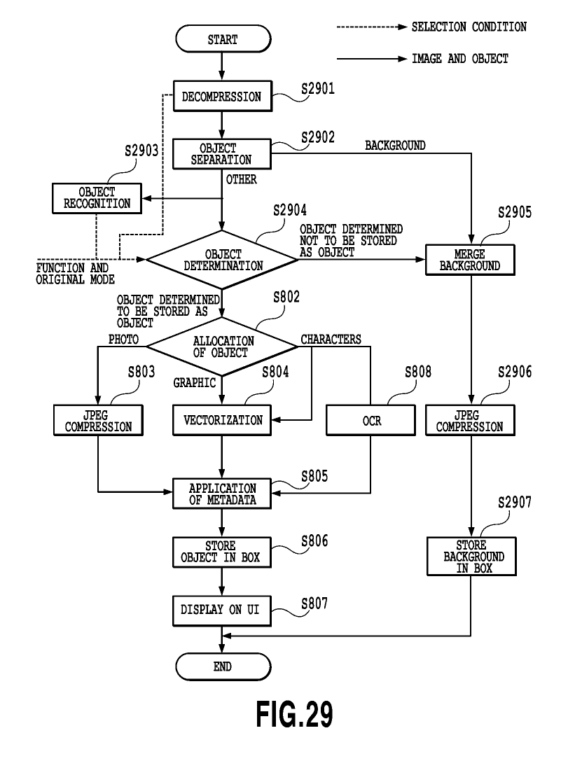

The following section will describe an example of object separating in this embodiment. FIG. 29 is a flowchart illustrating an example of the details of Step S404 in this embodiment.

First, Step S2901 decompresses the compressed bitmap image stored in S403. The decompression may be executed using a decompression coefficient corresponding to the compression coefficient used in the compression. The used decompression coefficient is used as a reference to determine whether the object is stored or not in Step S2904.

Step S2902 subjects the bitmap image data to the object separation. When the separation result shows an object other than the background object (OTHER in Step S2902), then processing proceeds to Step S2904 where it is determined whether to store the object as an object or not, as well as the image recognition of Step S2903. When the separation result shows a background object (BACKGROUND in step S2902), processing proceeds to step S2905.

The determination in Step S2904 also uses the result of the image recognition in Step S2903. The image recognition in Step S2903 uses a general image analysis technique including, for example, the use of a parameter showing the image quality (e.g., image dispersion, S/N, edge feature amount). The output of this analysis result shows the complexity or the complexity level of the object.

In Step S2904, the object determined not to be stored as an object (OBJECT DETERMINED NOT TO BE STORED AS AN OBJECT in Step S2904) is merged by Step S2905 with a background object. The merged background object is subjected by Step S2906 to a JPEG compression. The resultant object is stored by Step S2907 in the BOX 111 as a background object, after which processing may be ended.

In Step S2904, the object determined to be stored as an object (OBJECT DETERMINED TO BE STORED AS OBJECT in Step S2904) is subjected to the same processings as the processings after Step S802 in FIG. 8. However, a background object is not processed in S2904 and thus is not processed in Step S802.

### [Object Storing Determination (Details of S2904)]

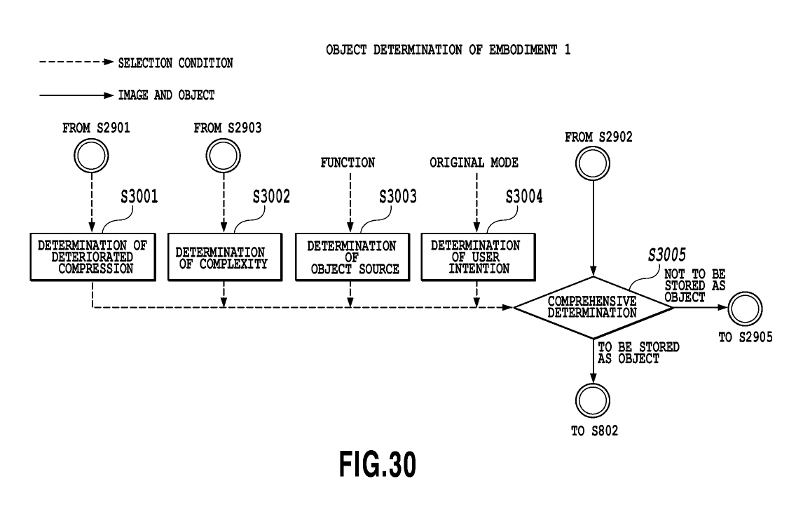

FIG. 30 is a flowchart illustrating an example of the details of Step S2904 in this embodiment.

The object storage determination processing step S2904 determines whether the separated object is stored as an object or not.

First, Step S3001 determines, based on the decompression coefficient used in Step S2901 (FIG. 29), the image status by the compression of the bitmap image. When the decompression coefficient is high, then the compression coefficient in the compression is also high. When the compression and decompression coefficients are high (specifically, in the case of a compression coefficient to compress a standard image to have a 1/16 or smaller size), the image deteriorated significantly. An influence by the deteriorated image on the visual perception is different depending on whether the image includes signals of various colors as in the case of a natural image or includes signals of less colors as in the case of a character image. For example, even when the same compression and decompression coefficients are used, the deterioration may not be conspicuous in a natural image but can cause a great amount of noise in a character or line image. Thus, when the result of the object separation S2902 (FIG. 29) determines that the image is a character or graphic image, then the influence by the deterioration in the compression may be high. A color histogram of the object also can be used to predict the degree of the deterioration. Specifically, when the object uses a smaller compression or decompression coefficient, is separated to an image by the object separation, and has more colors, the object can be reused with a higher probability. From the viewpoint as described above, based on whether the object can be reused or not, an evaluation value showing whether the object is stored as an object or not is outputted.

Next, Step S3002 determines the complexity of the object based on the result of the object recognition in Step S2903 (FIG. 29). When the object is complex, it means that the object may be actually composed of two or more superposed objects and thus the vectorization may fail with a high probability. Thus, an object having a lower complexity or complexity level can be reused with a higher probability. From the viewpoint as described above, based on whether the object can be reused or not, an evaluation value showing whether the object is stored as an object or not is outputted.

Next, Step S3003 determines the quality of the object based on the input form used when the object is inputted in the MFP 100. The input form represents PDL or scan. PDL shows that the original data is digital data on a PC and thus provides an object source of a high quality. From the viewpoint as described above, based on whether the object can be reused or not, an evaluation value showing whether the object is stored as an object or not is outputted.

Next, Step 3004 determines, based on the original document mode used in the MFP 100 to input the object, which object is considered as the important and/or preselected one. The original document mode includes a character mode in which an original character document is subjected to an optimal image processing, a photo mode in which an original photo document is subjected to an optimal image processing, and a character/photo mode for carrying out a mixed processing. The document mode is a setting specified by a user. Thus, an object considered as the important and/or preselected one by the user can be determined based on the selected original document mode. From the viewpoint as described above, based on whether the object can be reused or not, an evaluation value showing whether the object is stored as an object or not is outputted.

Finally, since there is a possibility where the evaluation values of the object obtained in Step S3001 to Step S3004 are used to reuse the object, Step S3005 determines whether to store the object as an object or not.

For example, Step S3001 puts an evaluation value of 0 to a high compression rate such as the one to compress a standard image to have a size equal to or smaller than one sixteenths and puts an evaluation value of 2 to a compression rate lower than this compression rate.

Next, Step S3002 similarly puts an evaluation value of 1 to two superposed objects, puts an evaluation value of 0 to two or more superposed objects, and puts an evaluation value of 2 to a not-superposed object.

Similarly, Step S3003 puts an evaluation value of 2 to an image obtained by PDL and puts an evaluation value of 0 to a scanned image.

Finally, Step S3004 puts an evaluation value of 2 to a photo object when the user uses a photo mode during a scanning operation and puts an evaluation value of 0 to a photo object when the user uses a character mode during a scanning operation.

The total of these evaluation values is calculated in the comprehensive determination in Step S3005. An object for which the total exceeds a certain point (i.e., an object for which the total exceeds a fixed threshold value) may be reused. Thus, such an object is determined to be stored as an object (TO BE STORED AS OBJECT in Step S3005), and processing may proceed to step S802. If the total does not exceed a certain point, the object may not be reused, and the object is determined not to be stored as an object (NOT TO BE STORED AS OBJECT in Step S3005), and processing may proceed to Step 2905.

The threshold value can be set by a user or a person in charge of control in advance by setting that an object having an evaluation point of 3 or more for example is determined as having a value to be reused for example.

When any of the evaluation values obtained in Step S3001 to Step S3004 is 0, then the object may be determined as having a low probability of being reused and may be determined not to be stored as an object.

Although the determination result depends on each evaluation value or a threshold value, a determination as shown below may be assumed.

When the original document scanned in a photo mode is subjected to the object separation and has high compression and decompression coefficients for example, then the character object may be reused with a high probability and thus the object is not stored as an object. Since a photo object has a probability of being reused, the photo object is determined to be stored. The reason is that the fact that the photo mode is set by the user means that the photograph is highly important and thus some deterioration maybe permitted. When the original document scanned by the user in the character mode is subjected to the object separation and has high compression and decompression coefficients for example, the character object has a high probability of being reused and thus is stored as an object. In this case, the photo object has a low probability of being reused and thus is determined not to be stored as an object.

The object that is determined as having a probability of being reused and that is thus determined to be stored as an object may be subjected to the processings after S802 (FIG. 8). The object that is determined as having no probability of being reused may be subjected to the processings after S2905 (FIG. 29).

The embodiment allows a user who reuses an object to have a reduced burden. This is because whether to store an object or not is automatically determined regarding a probability of the object being reused and a storage method of an object that has a high probability of being reused and is determined to be stored as an object is changed, according to the embodiment.

Aspects of the present invention thus allow for the selection of one or more objects suitable for reuse from among separately stored objects to store the selected object(s) separately as an object and show a user only the separately stored object(s). Other aspects of the present invention allow a user to decide a criterion with which whether the separated object is stored as an object or not is determined.

According to aspects of the present invention, whether an object is suitable for reuse or not is determined and the determination result may be shown to a user. This eliminates a case where an object that should be a background image is mistakenly presented to a user as a character, photograph, or graphic object, and hereby a burden on a user can be reduced. Furthermore, a criterion with which a user determines whether an object is suitable for reuse or not can be variably set, and thus a determination can be made in accordance with a user's intention.

Next, Embodiment 2 of the image processing method according to the present invention will be described with reference to the drawings. It is noted that configurations and flowcharts already described in Embodiment 1 will not be further described. The following section will describe features of this embodiment.

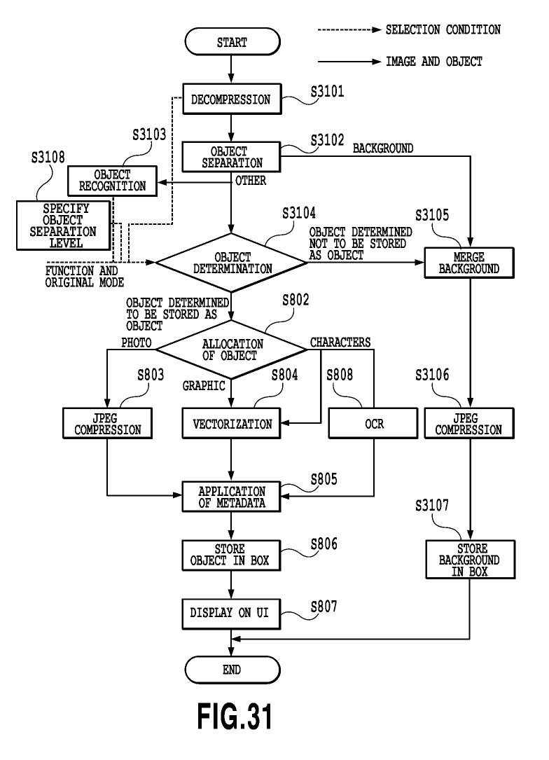

FIG. 31 shows a flowchart of Embodiment 2. First, Step S3101 decompresses the compressed bitmap image stored in S403 of FIG. 4. The decompression uses a decompression coefficient corresponding to the compression coefficient used in the compression. The used decompression coefficient is used as a reference to determine whether the object is stored or not in Step S3104. Step S3102 subjects the bitmap image data to the object separation. As described above, the object types after the object separation may include one or more of character, photograph, graphics (diagram, line, table), and background. When the result of the object separation shows an object other than a background object (OTHER in Step S3102), then Step S3104 determines whether to store the object as an object or not, and processing also proceeds to object recognition in Step S3103. If the result of object separation shows a background object (BACKGROUND in Step S3102), processing proceeds to step S3105.

The determination in Step S3104 also uses the result of the image recognition in Step S3103. The image recognition in Step S3103 uses a general image analysis technique including, for example, the use of a parameter showing the image quality (e.g., image dispersion, S/N, edge feature amount). The output of this analysis result shows the complexity or the complexity level of the object.

The determination in Step S3104 also uses the result in Step S3108 of the specification of an object separation level. The specification of an object separation level is set by a user in advance and specifies an object separation level. The separation level represents how the object can be easily stored as an object.

In other words, a threshold value in order to determine whether the object is an object that is suitable for reuse or not can be set by a user by allowing the user to specify an object separation level (S3108). Thus, a storage judgment criterion incorporating the intention of the user can be set.

An object that is determined as having no probability of being reused and that is determined not to be stored as an object in Step S3104 (OBJECT DETERMINED NOT TO BE STORED AS AN OBJECT in Step S3104) is merged in Step 3105 with a background object. The merged background object is subjected in Step S3106 to a JPEG compression. Then, the object is stored in the BOX 111 as a background object in Step S3107, after which processing may be ended.

An object that is determined as having a probability of being reused and that is determined to be stored as an object in Step S3104 (OBJECT DETERMINED TO BE STORED AS OBJECT in Step S3104) on the other hand is subjected to the same processings as those after Step S802 in FIG. 8. However, a background object is not processed in S3104 and thus is not processed in Step S802.

### [Object Storing Determination (Details of S3104)]

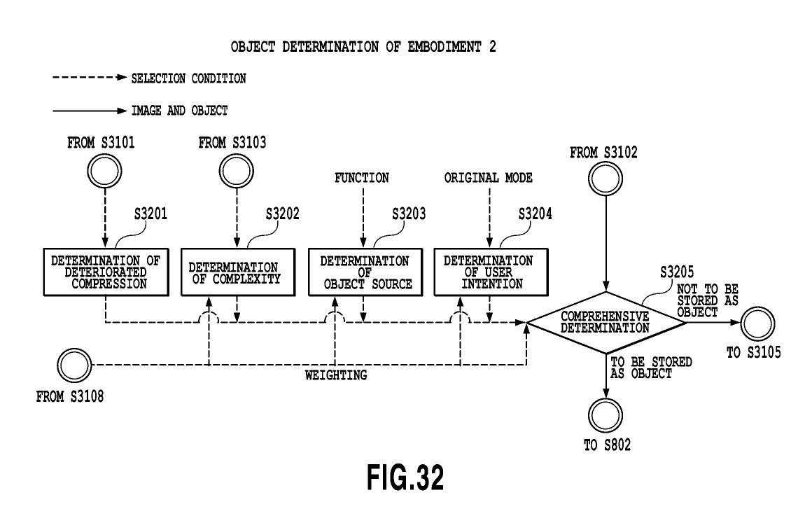

FIG. 32 is a flowchart illustrating an example of the details of Step S3104 in this embodiment. In an object storage determination block S3104, the object is determined with regard to whether the object is stored as an object or not in view of a probability at which the separated object is reused (with a fixed image quality).

First, Step S3201 determines the image status by the compression of the bitmap image based on the decompression coefficient used in Step S3101 of FIG. 31. The higher the decompression coefficient is, the higher the compression coefficient during the compression is. High compression and decompression coefficients mean a highly-deteriorated image. An influence by the deteriorated image on the visual perception is different depending on whether the image includes signals of various colors as in the case of a natural image or includes signals of less colors as in the case of a character image. For example, even when the same compression and decompression coefficients are used, the deterioration may not be conspicuous in a natural image but may cause a great amount of noise in a character or line image. Thus, when the result of the object separation S3102 (FIG. 31) determines that the image is a character or graphic image, then the influence by the deterioration in the compression may be high. A color histogram of the object also can be used to predict the degree of the deterioration. Specifically, when the object uses a smaller compression or decompression coefficient, is separated to an image by the object separation, and has more colors, the object can be reused with a higher probability. From the viewpoint as described above, based on the probability of being reused of the object, an evaluation value showing whether the object is stored as an object or not is determined and outputted. The evaluation value may be weighted based on the object separation level specified in Step S3108 (FIG. 31) and the resultant evaluation value may be outputted.

Thus, even when a high compression coefficient is used for the object, the object can be easily determined as having a high probability of being reused and is determined to be stored as an object if the object is set by a user as having “a high object separation level”.

Next, Step S3202 determines the complexity of the object based on the result of the object recognition in Step S3103 (FIG. 31). When the object is complex, it means that the object may be actually composed of a plurality of superposed objects and thus the vectorization may fail with a high probability. Thus, an object having a lower complexity or complexity level can be reused with a higher probability. From the viewpoint as described above, whether the object is stored or not is determined and the evaluation value is outputted. Then, the evaluation value is weighted based on the object separation level specified in Step S3108 and the resultant evaluation value is outputted.

Thus, even when an object is composed of a great number of superposed objects, the object can be easily determined to be stored as an object if the user sets the object as having “a high object separation level” in advance to show a high probability at which the object is reused.

Next, Step S3203 determines the quality of the object source based on the function used in the MFP 100 when the object is inputted. The function means PDL or scan. PDL shows that the original data is digital data on a PC and thus provides an object source of a high quality. From the viewpoint as described above, based on the probability at which the object is reused or not, an evaluation value showing whether the object is stored as an object or not is determined and outputted. The evaluation value is weighted based on the object separation level specified in Step S3108 (FIG. 31) and the resultant evaluation value is outputted.

Thus, even when an input image is a scanned image, the image can be relatively easily determined as being used as an object if the user sets the image as having “a high object separation level” in advance to show a high probability of being reused.

Next, Step 3204 determines which object is considered as the important and/or preselected one based on the original document mode used in the MFP 100 to input the object. The original document mode includes a character mode in which an original character document is subjected to an optimal image processing, a photo mode in which an original photo document is subjected to an optimal image processing, and a character/photo mode for carrying out a mixed processing. The document mode is a setting specified by a user. Thus, an object considered as the important and/or preselected one by the user can be determined based on the selected original document mode. From the viewpoint as described above, based on the probability of being reused of the object, an evaluation value showing whether the object is stored as an object or not is outputted. The evaluation value is weighted based on the object separation level specified in Step S3108 and the resultant evaluation value is outputted.

Thus, even when an image is not determined as the one considered to be important and/or preselected by the user, the image can be determined to be easily stored as an object if the user sets the image with “a high object separation level” in advance to show a high probability of being reused.

Finally, based on the probability at which the object is reused based on the evaluation values of the object obtained in Step S3201 to Step S3204, Step S3205 determines whether the object is stored as an object or not by adding the weight based on the object separation level specified in Step S3108 (FIG. 31) to the respective evaluation values to determine that the object has a high probability of being reused if the total value exceeds the threshold value based on the object separation level specified in Step S3108 to determine to store the object as an object (TO BE STORED AS OBJECT in Step S3205), and processing proceeds to Step S802. The other determination results show that the object has no probability of being reused to determine not to store the object as an object (NOT TO BE STORED AS OBJECT in Step S3205), and processing proceeds to Step S3105.

According to the embodiment, as described above, a storage method of an object is determined regarding a probability of being reused, which clearly reflects an intention of a user.

An object that is determined to have a probability of being reused and that is determined to be stored as an object is subjected to the processings after S802 (FIG. 8). An object that is determined to have no probability of being reused and that is determined not to be stored as an object is subjected to the processings after S3105 (FIG. 31).

### [Specifying Object Separation Level (Details of S3108)]

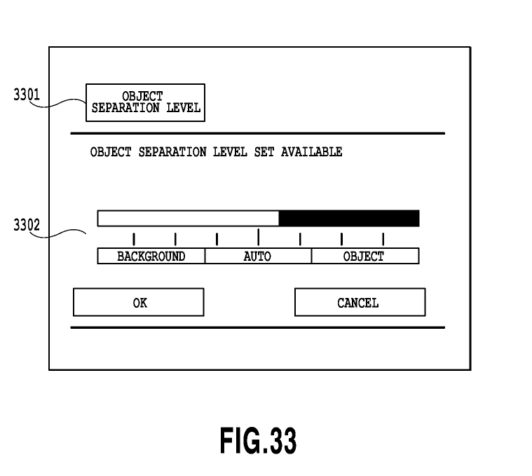

FIG. 33 shows an example of a screen through which an object separation level can be set. A screen 3301 is a screen through which an object separation level is set. In this illustrative diagram, a bar 3302 is used to select the level. A position closer to the left side of the bar 3302 means that the object is more difficultly stored as an object and thus is likely a background. A position closer to the right side of the bar 3302 means that the object is more easily stored as an object.

A setting according to which the object is likely a background means a setting specifying that the object value is determined so that only an object that is a single object with a high probability (i.e., low complexity or complexity level) and that has a high image quality should be stored as an object. Specifically, this setting means reduced images to be stored as an object.

A setting according to which an object is relative easily stored as an object means a setting specifying that the object value is determined so that even an object that is composed of superposed objects (i.e., high complexity or complexity level) or that is determined to have a poor image quality should be stored as an object. Specifically, this setting means increased images to be stored as an object.

Although FIG. 33 shows the setting of an object level by the bar 3302, the level setting also can be achieved by a numeric value for example. Specifically, a level value range from −5 to +5 having the center of 0 can be used and a higher negative value can be set to more easily store the object as background data and a higher positive value can be set to more easily store the object as an object. This range can be displayed so that the user can specify a value. Another configuration also may be used where the positive and negative sides have opposite meanings to the above-described ones. The value range and a step size are not limited to the above-described ones. In other words, the level can be set by any method so long as the method can show the level.

Other examples of the processing to specify the object separation level S3108 (FIG. 31) will be described. The above-described method of the processing S3108 for specifying an object separation level was set to the level showing how the object can be easily separated as shown in the example of FIG. 33. Another method also can be used to indirectly specify the level showing how the object can be easily separate by weighting the selection conditions for classifying the object. In the example of FIG. 32, those corresponding to the selection conditions are an original document mode, a function, deteriorated compression, and object recognition result (complexity). With regard to these selection conditions, which selection condition should be considered as the important and/or preselected one or should be ignored is set to specify the object separation. In this specification, in addition to the setting regarding which selection condition should be considered as the important and/or preselected one or should be ignored, how much the selection condition is considered as the important and/or preselected one also may be set by specifying the level.

The present invention may also achieved by attaching a recording medium storing therein a program code of software having computer-executable instructions realizing the above-described functions of aspects of the invention to a system or an apparatus to allow a computer such as the system to read the program code from the recording medium to execute the program code and instructions therein. The recording medium is a computer-readable recording medium. In this case, the program code itself read out from the recording medium may realize at least some of the above-described functions according to aspects of the invention and the recording medium storing therein the program code may itself constitute an embodiment of the invention. Another configuration also may be used where an operating system (OS) operating on the computer partially or entirely carries out the actual processing based on the instructions by the program code to realize the above-described functions according to aspects of the invention by the processing. Another configuration also may be used where the program code read out from the recording medium is written to a function expansion card or a function expansion unit of a computer to allow the function expansion card for example to partially or entirely carries out the processing based on the instruction by the program code to realize aspects according to the invention.

When the present invention is used in the recording medium, the recording medium may store therein a program code corresponding to one or more of the flowcharts as described above.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

The present application claims the benefit of Japanese Patent Application No. 2008-032267, filed Feb. 13, 2008, which is hereby incorporated by reference herein in its entirety.

What is claimed is:

1. An image processing apparatus, comprising:
a separation unit for separating objects constituting an image input by an image input unit;
a setting unit for setting a criterion to determine whether or not a separated object is stored;
a determination unit for determining whether the separated object is stored based on the criterion set by the setting unit; and
a unit for displaying the separated object, responding to a user access via an interface unit, when the separated object is determined to be stored by the determination unit and storing the separated object such that the separated object can be reused.

2. The image processing apparatus according to claim 1, wherein:
if the separated object is determined to be stored by the determination unit, the separated object is subjected to compression when the separated object is a photo image or a background image, the separated object is subjected to vectorization when the separated object is a graphics image, and the separated object is subjected to vectorization or optical character recognition when the separated object is a character.

3. The image processing apparatus according to claim 1, wherein:
the determination unit uses, as the criterion to determine whether a separated object is stored or not, at least one of:
a compression coefficient used when a separated object determined not to be stored is input by the image input unit,
an input form used when the separated object is input by the image input unit,
complexity of the separated object after the separated object is separated by the separation unit, and
a setting of an original document mode used when the separated object is inputted by the image input unit.

4. An image processing method, the method comprising:
separating objects constituting an image inputted by an image input unit;
setting a criterion to determine whether a separated object is stored or not;
determining whether the separated object is stored or not based on the criterion set in the setting step; and
displaying the separated object, responding to a user access via an interface unit, when the separated object is determined to be stored in the determination step and storing the separated object such that the separated object can be reused.

5. The image processing method according to claim 4, further comprising:
if the separated object is determined to be stored, of subjecting the separated object to a predetermined process, wherein in the predetermined process the separated object is subjected to compression when the separated object is a photo image or a background image, the separated object is subjected to vectorization when the separated object is a graphics image, and the separated object is subjected to vectorization or optical character recognition when the separated object is a character.

6. The image processing method according to claim 4, wherein:
the determination, as the criterion to determine whether a separated object is stored or not, at least one of:
a compression coefficient used when the separated object determined not to be stored is input by the image input unit,
an input form used when the separated object is input by the image input unit,
complexity of the separated object after the separated object is separated by the separation unit, and
a setting of an original document mode used when the separated object is inputted by the image input unit.

7. A computer readable medium storing a program code thereon having computer-executable instructions for causing a computer to execute processing, the computer readable medium comprising:
computer-executable instructions for separating objects constituting an image inputted by an image input unit;
computer-executable instructions for setting a criterion to determine whether a separated object is stored or not;
computer-executable instructions for determining whether the separated object is stored or not based on the criterion set in the setting step; and
computer-executable instructions for displaying the separated object, responding to a user access via an interface unit, when the separated object is determined to be stored in the determination step and storing the separated object such that the separated object can be reused.
